(19) United States
(12) Patent Application Publication
(10) Pub. No.: US 2010/0320908 A1
(43) Pub. Date: Dec. 23, 2010

(54) Light emitting diode illumination apparatus and power supply module thereof

(75) Inventors: Nien-Hui Hsu, Hsin-Chu (TW); Chao-Nan Chien, Hsin-Chu (TW); Ken-Chih Chang, Hsin-Chu (TW); Tung-Min Lee, Hsin-Chu (TW)

Correspondence Address: BACON & THOMAS, PLLC, 625 SLATERS LANE, FOURTH FLOOR, ALEXANDRIA, VA, 22314-1176, US

(73) Assignee: YOUNG GREEN ENERGY CO., Hsinchu County (TW)

(21) Appl. No.: 12/659,590

(22) Filed: Mar. 15, 2010

(30) Foreign Application Priority Data
Jun. 18, 2009 (TW) 098120376

(51) Int. Cl. H05B 37/02

(52) U.S. Cl. 315/51

(57) ABSTRACT

A power supply module is formed as a package body suitable to be assembled in a light emitting diode illumination apparatus. The power supply module includes a light emitting diode driver, a feedback control unit, a current converting unit, and a package material. The light emitting diode driver, the feedback control unit, and the current converting unit are packaged integrally by the package material. The current converting unit is suitable for supplying power to the light emitting diode driver and the feedback control unit. The feedback control unit is suitable to receive a feedback signal from a light source module disposed outside of the package body and provide an adjusting signal to the light emitting diode driver, so as to make the light emitting diode driver to adjust the magnitude of a control current and provide the control current to the light source module.

### BACKGROUND OF THE INVENTION

(1) Field of the Invention

The invention relates to an illumination apparatus and a power supply module thereof, particularly to an light emitting diode illumination apparatus and a power supply module thereof.

(2) Description of the Related Art

Owning advantages of energy-saving and high efficiency, light emitting diode illumination apparatus may be the trend in the future. However, life and brightness of the light emitting diode are easily affected by the temperature, thus thermal dissipation becomes an important issue for the light emitting diode illumination apparatus.

In practical application, besides a stable thermal dissipation module, the light emitting diode illumination apparatus also needs an over-temperature protection system to prevent the light emitting diode from burning down due to high temperature. The common over-temperature protection system is shown in FIG. 1 and FIG. 2.

FIG. 1 shows a conventional light emitting diode illumination apparatus 100 and an over-temperature protection system 101 thereof. The over-temperature protection system 101 includes a thermal sensor 120, a controller 140 and a switch 160. The thermal sensor 120 is adjacent to the light emitting diode unit 110 and electrically connected to the controller 140. The controller 140 is electrically connected to the switch 160 of the light emitting diode driver 130. If the thermal sensor 120 detects the temperature too high, the switch 160 is turned off by the controller 140 to stop the light emitting diode driver 130 for over-temperature protection.

FIG. 2 shows a light emitting diode illumination apparatus 200 and an over-temperature protection system 201 thereof disclosed by TW patent No. M346110. The light emitting diode illumination apparatus 200 includes a light emitting diode 210, a heat sink 220, a fan 230, a thermal sensor 240, a fan control circuit 250, a current control portion 260, and a power converting unit 270. The thermal sensor 240 is adjacent to the light emitting diode unit 210 and electrically connected to the fan control circuit 250. The fan control circuit 250 is electrically connected to the current control portion 260. The power converting unit 270 provides power to the fan control circuit 250 and the current control portion 260.

According to the temperature measured by the thermal sensor 240, if the fan control circuit 250 detects the temperature around the light emitting diode unit 210 too high, the fan control circuit 250 starts the fan 230 and notifies the current control portion 260 to adjust the current inputted to the light emitting diode unit 210 in order to control the temperature and brightness of the light emitting diode unit 210 for over-temperature protection.

Moreover, US publication No. 20090026957 discloses in details that the abnormal signal of the fan, such as low speed or error, is used to start the switch to branch the current of the light emitting diode for over-temperature protection.

However, the above conventional technology still has disadvantages as follows:

1. Referring to FIG. 1, when the temperature measured by the thermal sensor is too high, the light emitting diode driver stops providing power to the light emitting diode such that the light emitting diode is turned off and stops emitting light. However, when applied in outdoor illumination, if the light emitting diode lamp is turned off in a sudden before the passerby could react, accident may happens.

2. Referring to FIG. 2, if the driving current of the light emitting diode changes with the temperature of the thermal sensor to adjust the brightness of the light emitting diode, the light emitting diode flashes continuously.

3. For the outdoor illumination, the light emitting diode illumination apparatus must be waterproof and dustproof. In FIG. 1, the controller 140 and the light emitting diode unit 110 of the light emitting diode illumination apparatus 100 take waterproof and dustproof treatment separately, suffering from not only high cost, but also complexity and low reliability. In FIG. 2, the light emitting diode unit 210, the current control portion 260, and the fan control circuit 250 of the light emitting diode illumination apparatus 200 take waterproof and dustproof treatment in together, also suffering from high cost and complexity. The reasons are that the light emitting diode units 110 and 210 are optical components including lens, lampshade and other light emitting structures, and the optical components are difficult to integrate with general control chip and other electrical components, and properties of the electrical components are also affected by temperature of the light emitting diode units 110, 210.

### SUMMARY OF THE INVENTION

Accordingly, the object of the invention is to provide a power supply module being waterproof and dustproof, applied to in a light emitting diode illumination apparatus, capable of providing power and over-temperature protection for the light emitting diode.

To achieve at least one of the above-mentioned advantages, an embodiment of the invention provides a power supply module adapted to be assembled in a light emitting diode illumination apparatus. The power supply module is formed as a package body and includes a light emitting diode driver, a feedback control unit, current converting unit, and a package material. The package material includes a waterproof material, and is packaged outside of the light emitting diode driver, the feedback control unit, and the current converting unit. The current converting unit is capable of providing power to the light emitting diode driver and the feedback control unit. The feedback control unit is capable of receiving the feedback signal from the light source module disposed outside of the package body, and providing an adjusting signal to the light emitting diode driver so as to make the light emitting diode driver adjust the control current, and provide the control current to the light source module.

Another embodiment of the invention provides a light emitting diode illumination apparatus including a light source module, the above-mentioned package body. The light source module includes a light emitting diode and a feedback signal generating portion. The package body is electrically connected to the light source module via a power line and a signal line. The feedback control unit is capable of receiving the feedback signal from the feedback signal generating portion.

In an embodiment, the feedback signal generation portion includes a fan. The fan has a waterproof structure and is electrically connected to the feedback control unit of the package body. One end of the power line is connected to the light emitting diode driver, another end of the power line is disposed outside of the package body and electrically connected the light emitting diode. One end of the signal line is connected to the feedback control unit, another end of the signal line is disposed outside of the package body and electrically connected to the fan.

In an embodiment, the feedback signal generation portion includes a temperature sensing unit, and the temperature sensing unit is electrically connected to the feedback control unit of the package body. One end of the power line is connected to the light emitting diode driver, and another end of the power line is connected to the light emitting diode. One end of the signal line is connected to the feedback control unit, and another end of the signal line is connected to the temperature sensing unit.

Accordingly, the feedback signal may be a fan error signal, a fan abnormal signal or a temperature abnormal signal.

In the above embodiments, the light emitting diode driver, the feedback control unit, and the current converting unit are packaged into an integration to form an power supply module. When applied to the light emitting diode illumination apparatus, the power supply module may judge if the light emitting diode illumination apparatus works normally or not, and facilitate the waterproof and dustproof design of the light emitting diode illumination apparatus, so the structure is beneficial for modularizing product process.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a conventional light emitting diode illumination apparatus and an over-temperature protection system thereof.

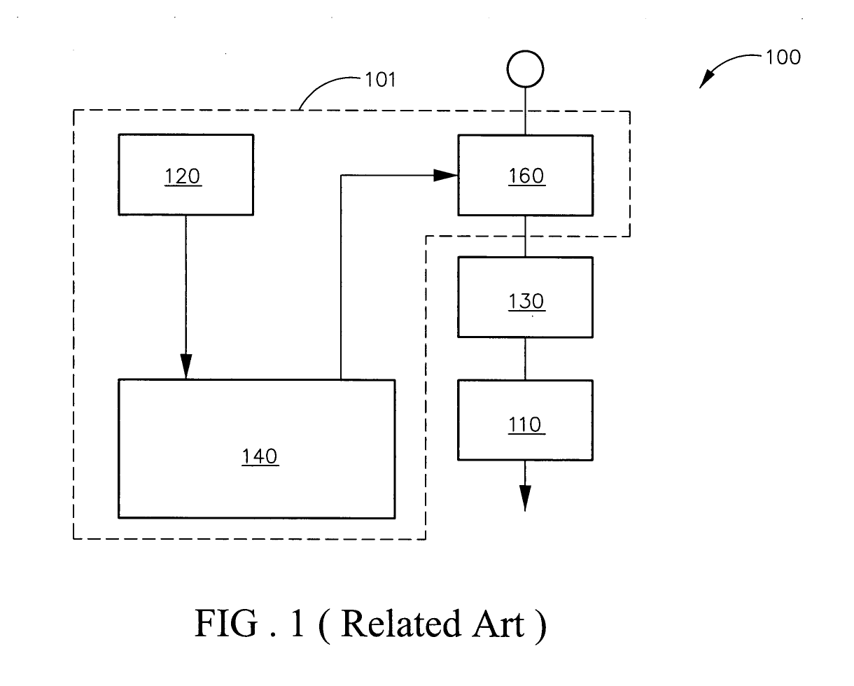

FIG. 2 is a conventional light emitting diode illumination apparatus and an over-temperature protection system thereof.

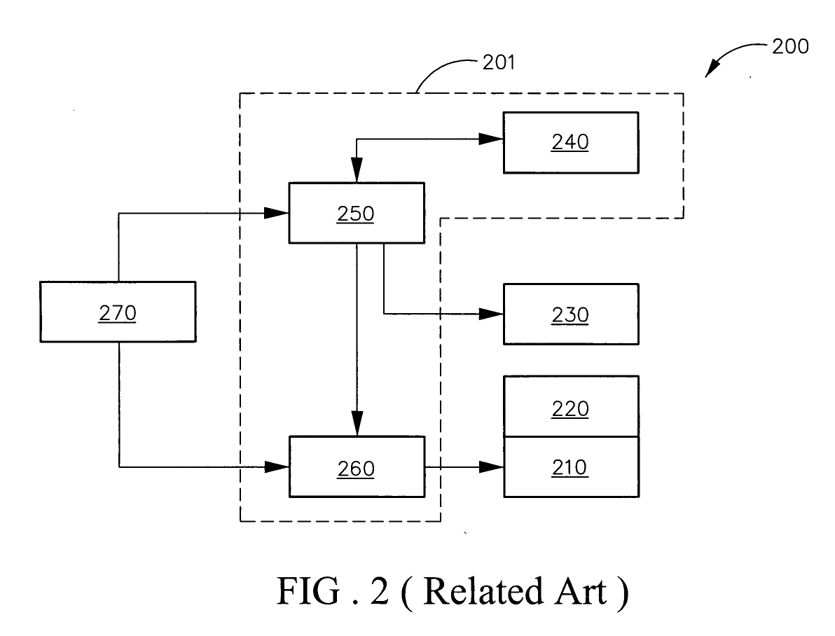

FIG. 3 is a schematic view of a power supply module in accordance with an embodiment of the invention.

FIG. 4 is a schematic view of a light emitting diode illumination apparatus in accordance with an embodiment of the invention.

FIG. 5 is a flow chart showing the over-temperature protection process of an light emitting diode illumination apparatus in accordance with an embodiment of the invention.

FIG. 6 is a schematic view of an light emitting diode illumination apparatus in accordance with an embodiment of the invention.

FIG. 7 is a flow chart showing the over-temperature protection process of the light emitting diode illumination apparatus in accordance with an embodiment of the invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

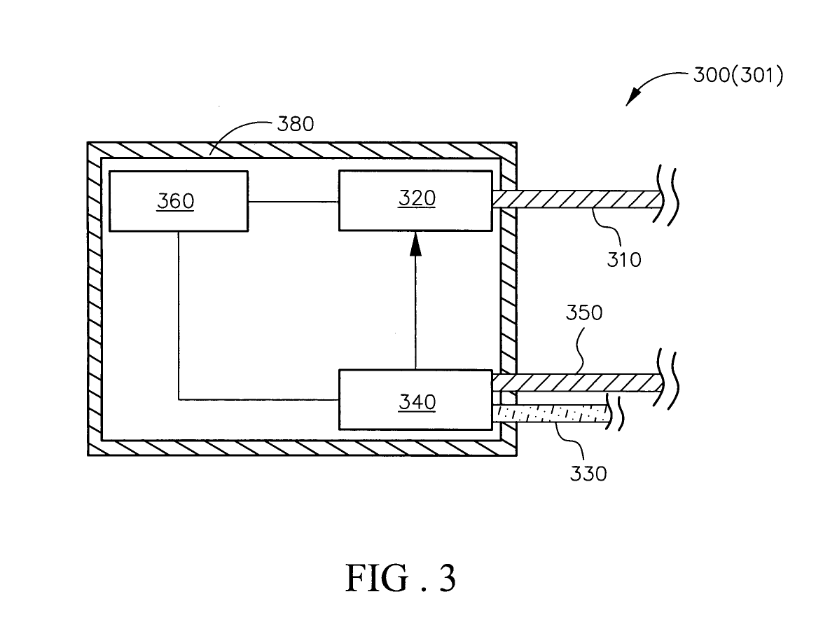

Please refer to FIG. 3, a power supply module 300 is formed as a package body 301 suitable to be assembled in a light emitting diode apparatus 400. The power supply module 300 (the package body 301) includes a light emitting diode driver 320, a feedback control unit 340, a current converting unit 360, and a package material 380. The package material 380 includes a waterproof material packaged outside of the light emitting diode 320, the feedback control unit 340, and the current converting unit 360.

The current converting unit 360 is electrically connected to the light emitting diode driver 320 and the feedback control unit 340, and is adapted to provide power to the light emitting diode driver 320 and the feedback control unit 340.

The light emitting diode driver 320 provides a control current to the light emitting diode (not shown) disposed outside of the package body 301 via a power line 310.

The feedback control unit 340 is electrically connected to the light emitting diode driver 320, and adapted to receive the feedback signal from a temperature sensing unit or a fan disposed outside of the package body 301 via a signal line 330. According to the feedback signal, the feedback control unit 340 provides an adjusting signal to the light emitting diode driver 320 to adjust the control current. In an embodiment, if the feedback control unit 340 is electrically connected to the fan outside of the package body 301, a power line 350 is added between the feedback control unit 340 and the fan so that the feedback control unit 340 may provide power to the fan.

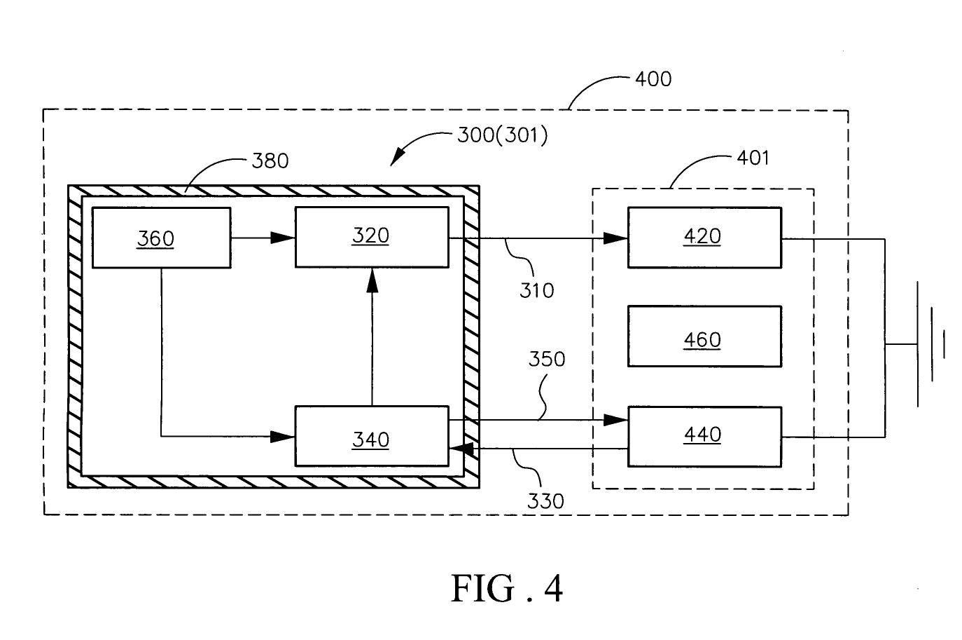

Please refer to FIG. 4, a light emitting diode illumination apparatus 400 includes a light source module 401 and a package body 301. The light source module 401 includes a light emitting diode 420, a heat sink 460, and a feedback signal generation portion. In the present embodiment, the feedback signal generation portion includes a fan 440. The heat sink 460 and the light emitting diode 420 are packaged integrally. The package body 301 is electrically connected to the light source module 401 via the power line 310 and the signal line 330.

The fan 440 has a waterproof or/and dustproof structure (not marked), and is electrically connected to the feedback control unit 340 of the package body 301. In the present embodiment, one end of the power line 310 is connected to the light emitting diode driver 320, and another end thereof is connected to the light emitting diode 420. One end of the signal line 330 is connected to the feedback control unit 340, and another end thereof is connected to the fan 440.

The feedback control unit 340 provides power to the fan 440 of the light source module 401 via the power line 350, and detects if the fan 440 is destroyed or not by receiving the feedback signal from the fan 440 such as an error signal or a speed abnormal signal. According to the feedback signal, the feedback control unit 340 may provide an adjusting signal to the light emitting diode driver 320. After receiving the adjusting signal, the light emitting diode driver 320 adjusts the control current, and further adjusts the brightness of the light emitting diode 420.

In the present embodiment, the power supply module 300 has the waterproof or/and dustproof material 380, and is electrically connected to the light source module 401 via the power lines 310, 350 and the signal line 330, so the light emitting diode 420, the heat sink 460, and the fan 440 of the light source module 401 may conveniently carry out the waterproof design separately or integrally. Consequently, the waterproof cost of the product becomes low. For example, each component of the light source module 401 may be packaged by glue for waterproofing. Meanwhile, the structure is also beneficial for the modular design.

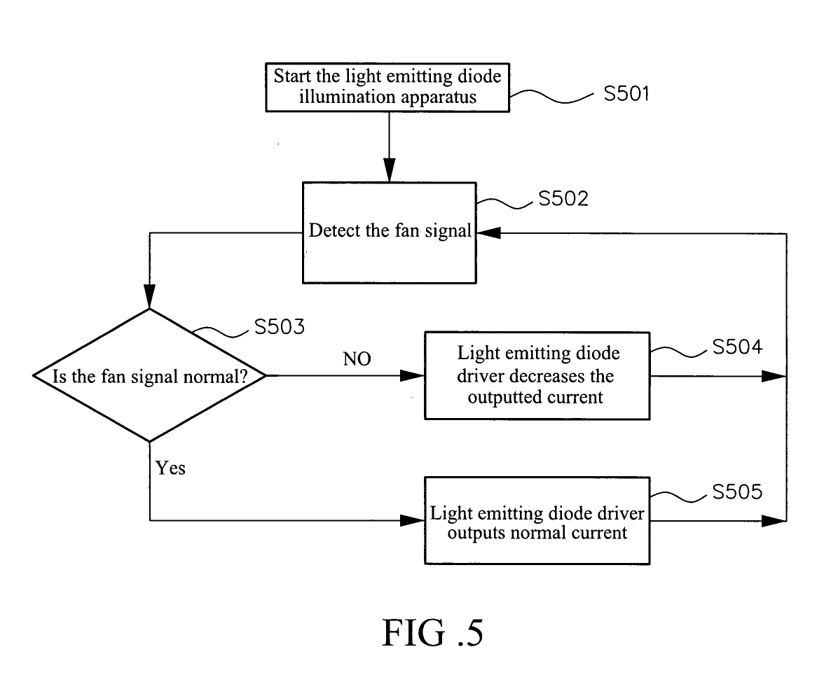

Please refer to FIG. 5. After the light emitting diode illumination apparatus 400 starts (S501), the feedback control unit 340 detects the fan signal to judge the status of the fan 440 at any time (S502). If the fan 440 is detected running normally, the feedback control unit 340 controls the light emitting diode driver 320 to output normal current (S503, S505). Otherwise, if the feedback control unit 340 detects the fan 440 working abnormally, the feedback control unit 340 sends out an adjusting signal to notify the light emitting diode driver 320 to decrease the control current outputted to the light emitting diode 420 (S503, S504).

The above embodiment may be applied to outdoor illumination, such as street lamps. After the fan is detected abnormal, besides decreasing the control current outputted to the light emitting diode, the feedback signal may be transmitted to a street lamp management system in order to grasp the status of the street lamps at the first time and inform the manufacturer to maintain at the earliest possible time. By the way, in this case, the street lamps is not turned off directly to affect the safety of passerby.

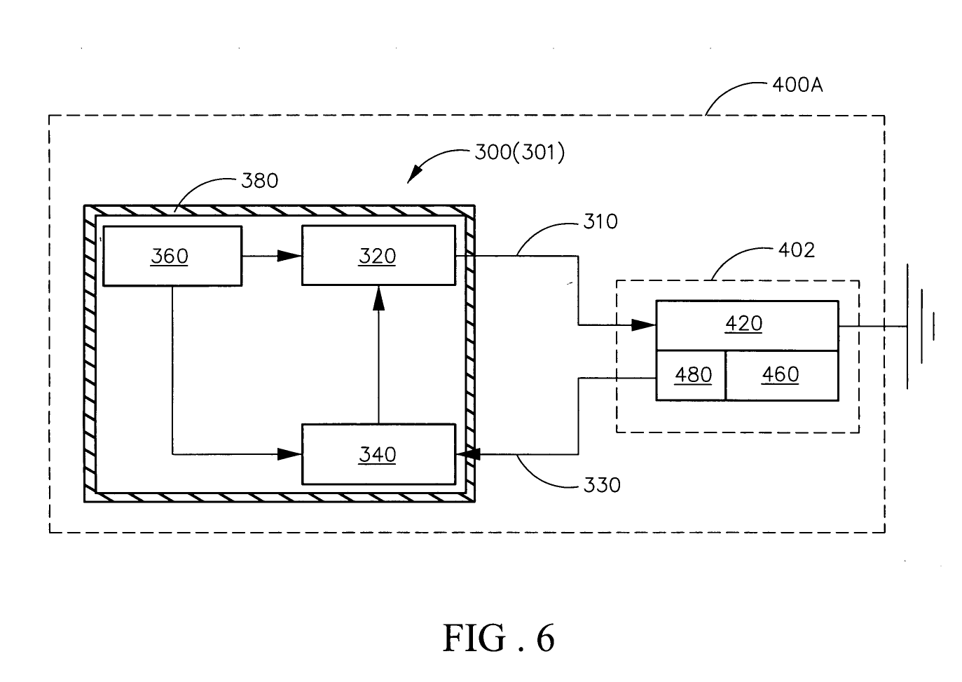

Please refer to FIG. 6. The feedback signal generation portion of the light source module 402 includes a temperature sensing unit 480, such as thermistance, adjacent to the light emitting diode 420 for monitoring the temperature of the light emitting diode 420. The temperature sensing unit 480 is electrically connected to the feedback control unit 340 of the package body 301. In the present embodiment, one end of the power line 310 is connected to the light emitting diode driver unit 320, and another end of the power line 310 is connected to the light emitting diode 420. One end of the signal line 330 is connected to the feedback control unit 340, and another end of the signal line 330 is connected to the temperature sensing unit 480.

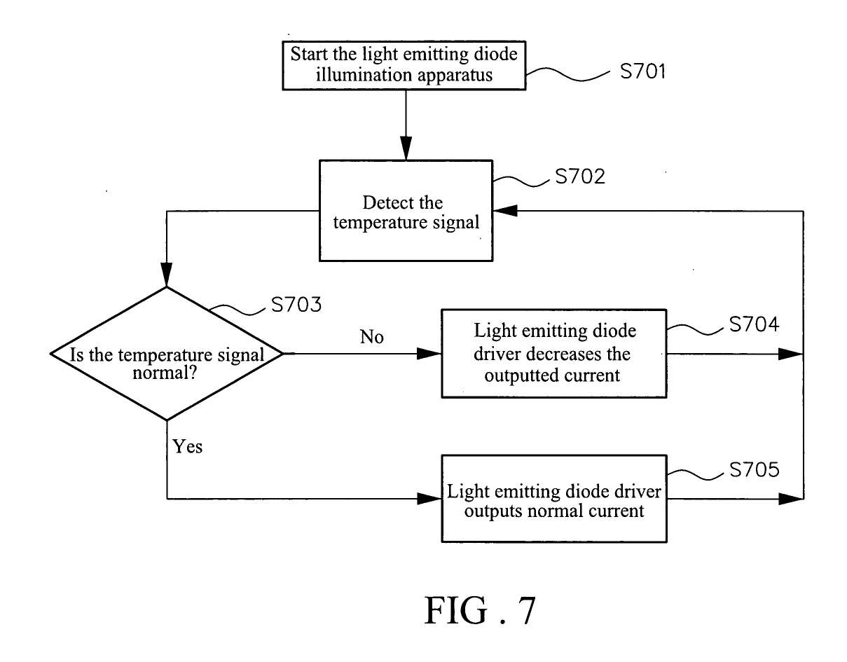

Please refer to FIG. 7. After the light emitting diode illumination apparatus 400A starts (S701), the feedback control unit 340 is adapted to capture the temperature signal detected by the temperature sensing unit 480 (S702). If the temperature is detected normal, the feedback control unit 340 controls the light emitting diode driver 320 to output the normal current (S703, S705). Otherwise, if the feedback control unit 340 detects an abnormal temperature signal, for example, the temperature higher than the preset temperature, the feedback control unit 340 sends out an adjusting signal to notify the light emitting diode driver 320 to decrease the control current outputted to the light emitting diode 420 (S703, S704).

In the above embodiments, the light emitting diode driver, the feedback control unit, and the current converting unit are packaged into an integration to form an power supply module. When applied to the light emitting diode illumination apparatus, the power supply module may judge if the light emitting diode illumination apparatus works normally or not according to the feedback signal, such as a fan error signal, a fan speed abnormal signal or a temperature abnormal signal, and facilitate the waterproof and dustproof design of the light emitting diode illumination apparatus or other electrical components, and the structure is beneficial for modularizing product process.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A power supply module, formed as a package body and adapted to be assembled in a light emitting diode illumination apparatus, comprising:
a light emitting diode driver, capable of providing a control current to a light source module disposed outside of the package body;
a feedback control unit, electrically connected to the light emitting diode driver and capable of receiving a feedback signal from the light source module;
a current converting unit, capable of providing power to the light emitting diode driver and the feedback control unit, wherein the feedback control unit is capable of receiving the feedback signal and providing an adjusting signal to the light emitting diode driver so as to make the light emitting diode driver adjust the control current; and
a package material, packaged outside of the light emitting diode driver, the feedback control unit, and the current converting unit.

2. The power supply module of claim 1, wherein the package material comprises a waterproof material.

3. The power supply module of claim 1, further comprising a power line and a signal line, wherein one end of the power line is connected to the light emitting diode driver, another end of the power line is disposed outside of the package body, and one end of the signal line is connected to the feedback control unit, another end of the signal line is disposed outside of the package body.

4. The power supply module of claim 1, wherein the light source module comprises a fan capable of providing the feedback signal to the feedback control unit, and the feedback control unit is capable of providing power to the fan.

5. The power supply module of claim 1, wherein the light source module comprises a temperature sensing unit, and the temperature sensing unit is capable of providing the feedback signal to the feedback control unit.

6. The power supply module of claim 1, wherein the feedback signal is selected from a group consisting of a fan error signal, a fan abnormal signal, and a temperature abnormal signal.

7. A light emitting diode illumination apparatus, comprising:
a package body, comprising a light emitting diode driver, a feedback control unit, and a current converting unit, wherein the current converting unit is capable of providing power to the light emitting diode driver and the feedback control unit; and
a light source module located outside of the package body, comprising a light emitting diode and a feedback signal generating portion, wherein the light emitting diode is electrically connected to the light emitting diode driver, and the feedback signal generation portion is adjacent to the light emitting diode and electrically connected to the feedback control unit,
wherein the feedback control unit is capable of receiving the feedback signal from the feedback signal generating portion and providing an adjusting signal to the light emitting diode driver in accordance with the feedback signal, and the light emitting diode driver is capable of receiving the feedback signal and providing a control current to the light emitting diode.

8. The light emitting diode illumination apparatus of claim 7, wherein the package body comprises a waterproof material.

9. The light emitting diode illumination apparatus of claim 7, wherein the feedback signal generation portion comprises a fan, and the fan has a waterproof structure and is electrically connected to the feedback control unit of the package body.

10. The light emitting diode illumination apparatus of claim 9, further comprising a first power line, a second power line, and a signal line, wherein one end of the first power line is connected to the light emitting diode driver, another end of the first power line is connected to the light emitting diode, one end of the second power line is connected to the feedback control unit, another end of the second power line is connected to the fan, and one end of the signal line is connected to the feedback control unit, another end of the signal line is connected to the fan.

11. The light emitting diode illumination apparatus of claim 7, wherein the feedback signal generation portion comprises a temperature sensing unit, and the temperature sensing unit is electrically connected to the feedback control unit of the package body.

12. The light emitting diode illumination apparatus of claim 11, further comprising a power line and a signal line, wherein one end of the power line is connected to the light emitting diode driver, another end of the power line is connected to the light emitting diode, and one end of the signal line is connected to the feedback control unit, another end of the signal line is connected to the temperature sensing unit.

13. The light emitting diode apparatus of claim 7, wherein the feedback signal is selected from a group consisting of a fan error signal, a fan abnormal signal, and a temperature abnormal signal.
